(19) United States
(12) Patent Application Publication
(10) Pub. No.: US 2010/0228692 A1
(43) Pub. Date: Sep. 9, 2010

(54) SYSTEM AND METHOD FOR MULTI-MODAL BIOMETRICS

(75) Inventors: Valerie Guralnik, Orono, MN (US); Saad J. Bedros, West St. Paul, MN (US); Isaac Cohen, Minnetonka, MN (US)

Correspondence Address: HONEYWELL/SLW;Patent Services, 101 Columbia Road, P.O. Box 2245, Morristown, NJ, 07962-2245, US

(73) Assignee: Honeywell International Inc., Morristown, NJ (US)

(21) Appl. No.: 12/715,520

(22) Filed: Mar. 2, 2010

Related U.S. Application Data
(60) Provisional application No. 61/157,050, filed on Mar. 3, 2009.

(51) Int. Cl. G06F 15/18; G06N 5/02

(52) U.S. Cl. 706/12; 706/54; 706/55; 706/52

(57) ABSTRACT

A system and method relate to multi-modal biometrics. A single modality score is generated for each of a plurality of biometric modalities. A classifier is selected from a database of multi-modal classifiers, and a multi-modal fusion is applied to the single modality scores using the classifier. The single modality scores are then aggregated. A context dependent model is generated, and a measure of the context in which the biometric samples were obtained is applied to the aggregated single modality scores. It is then determined whether there is a match between two or more biometric samples.

### RELATED APPLICATIONS

The present application is related to U.S. Provisional Application No. 61/157,050, filed Mar. 3, 2009, which is incorporated herein by reference in its entirety.

### TECHNICAL FIELD

The present disclosure relates to biometric systems, and in an embodiment, but not by way of limitation, a multi-modal biometrics system.

### BACKGROUND

The increasing use of biometrics for various security tasks as well as military operations has motivated the development of a plethora of systems tailored to one or multiple biometrics. Integration and combination of these biometric systems has become a necessity to address some of the limitations of each system when used in tactical operations. Very often, in tactical operations, the biometric of interest is acquired in less than optimal conditions (e.g., in a standoff, with little to no subject collaboration, etc.), thereby reducing the accuracy of the biometric for recognition purposes. In these situations, the operator is often forced to use multiple biometrics to positively identify a person of interest with a high level of certainty. In practice, even with improved parametric classifier accuracy, there is still uncertainty in identifying a person, since a set of candidate matches with high scores is typically available. The art in therefore in need of a way to improve recognition performance of a biometric system.

### BRIEF DESCRIPTION OF THE DRAWINGS

FIG. 1 is a block diagram of an example embodiment of a multi-modal biometrics system.

FIG. 2 illustrates an example of an extension of gallery coverage within a same modality.

FIG. 3 is a graph illustrating a comparison of matching scores between individuals in IR and RGB camera galleries.

FIGS. 4A and 4B are a flowchart of an example embodiment of a multi-modal biometrics process.

FIG. 5 is a block diagram of a computer system that can be used in connection with one or more embodiments of the present disclosure.

### DETAILED DESCRIPTION

One way to improve recognition performance is to consider the context in which particular subjects are observed, since biometric probes are rarely acquired in isolation. The context, such as location and time of the biometric samples acquisition, combined with prior knowledge of association of subjects in the galleries, can provide ancillary information and can be used to further improve recognition and verification accuracy.

In an embodiment, the context and subject associations in a social network structure are embedded by modeling samples, their context, events, and people as nodes and their relationships and interactions as weighted dynamic edges in a graph. The weight represents causal strength (or correlation) between nodes. This embodiment is based on Bayesian conditional random fields (BCRFs) that jointly analyze all nodes of the network. Classification of each aggregated score affects the classification of each neighbor in the network. BCRFs are used to estimate posterior distribution of parameters during training and aggregate predictions at time of recognition. To avoid incorporating irrelevant context, a Bayesian feature selection technique is used in connection with BCRFs.

To support applicability of the system in different environments and to achieve continuous improvement of system performance, operator feedback is used to improve the multimodal matching of biometrics. Through continuous learning, the system adapts classification models and their parameters to the changes in biometric systems and situational context, and enables automatic configuration of the system in various environments to minimize deployment costs and improve initial recognition models.

A relevance feedback approach can be implemented to leverage the input provided by the operator for improving the multimodal matching of biometrics. This allows the operator to quickly perform multimodal matching on biometrics acquired in sub-optimal conditions.

An embodiment involves a context aware multimodal fusion of biometrics for identity management using biometrics acquired in less than optimal conditions. Similarities among subjects are leveraged across all biometric sensors with each modality to extend coverage of potential matches. Biometrics are fused using a small bank of classifiers that captures the performance of each biometric system. Context-aware data fusion leverages social networks (that is, knowledge about the scenario in which biometrics were acquired as well as prior knowledge of events, their locations, and relationships among enrolled people). Through continuous learning, context-dependent models adapt and operator feedback improves the accuracy of the multimodal biometrics system.

An embodiment includes an innovative approach to the fusion of multiple biometrics that overcomes the limitations faced by these biometrics systems in tactical operations. This embodiment addresses several challenges relating to an accurate multimodal fusion that is capable of adapting its analysis based on the available set of biometric systems, a robust matching in the presence of biometric systems with a variety of registered subject coverage and quality of samples, and a fast analysis from a large number of heterogeneous biometric systems.

To address these challenges, a context-aware system is capable of leveraging data in multiple galleries within each modality and producing accurate results even when some biometric modalities are not available. Key elements of this embodiment include an intra-modal fusion that leverages similarities among registered subjects in various biometric sensor galleries within each modality to improve matching regardless of type of biometric system used at matching time. Another element relates to a multimodal fusion classifier that aggregates scores using an appropriate classifier from a small bank that covers all possible subsets of biometric modalities and biometric systems. A context-aware data fusion analyzes biometric samples and their scores in the perspective of the context in which the biometrics were taken, as well as prior knowledge of events and associations of registered subjects in the galleries. The embodiment further includes continuous learning to adapt context-dependent models and proactively improve system performance.

An embodiment leverages a system that includes multimodal standoff acquisition and recognition, an example of which is Honeywell Corporation's Combined Face and Iris Recognition System (CFAIRS) and advanced analytics for fusing disparate set of information using a context aware framework.

While there are three primary levels of fusion, i.e., decision level, score level, and feature level, research has shown that score-level fusion is the most effective in delivering increased accuracy. At the score level, parametric machine learning algorithms are shown to outperform both non-parametric learning algorithms and voting schemes. However, a problem with parametric learning approaches is that they are based on assumptions that each biometric modality has a complete set of registered subjects and that the set is present at the time of recognition. One approach is to infer and compute the scores from missing modalities using known context or known dependencies among the biometric sensors or the subjects.

The known context and the relationship among subjects could be captured by a network that supports Bayesian reasoning for generating a probability distribution over all possible scores of missing modalities. Either the entire distribution or the most frequently occurring value with the highest probability can be selected as a replacement for the missing score, or the posterior probability of a missing score can be estimated via prior probability. This approach might not produce a robust analysis, because modalities are independent. Instead, it has been proposed, in the context of Support Vector Machine (SVM) classifiers, to use a bank of SVMs that cover all possible subsets of the biometric systems being considered. At the time of recognition or verification, an appropriate SVM is selected based on which biometric systems are available. If applied in a real system, it will have to generate 2ⁿ−(n+1) SVM classifiers for n biometric systems. While a number of modalities is relatively static (face, fingerprint, hand geometry, etc), new biometric sensors are always being developed, dramatically increasing the size of the classifier bank. Moreover, none of the current approaches leverage dependencies between biometric systems that capture the same modality (e.g., high resolution camera vs. low resolution cameras, electro-optical vs. near-infrared cameras) or use the characteristics of the sensor that generated the biometrics of interest to enable sensor independent compatibility of biometrics.

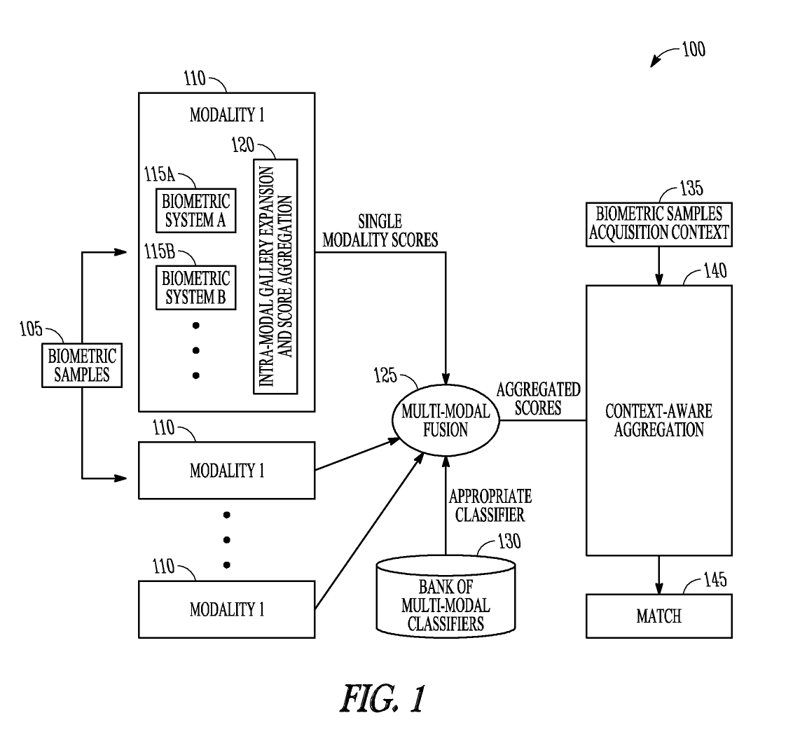

FIG. 1 illustrates an example embodiment of a multi-modal biometric system 100. The system 100 first aggregates scores from various biometric systems of biometric samples 105 within a single modality 110, thereby leveraging information in all galleries within that modality to expand coverage of available biometric systems. Each modality 110 can be associated with one or more biometric systems 115A/115B. A modality 110 can further include a module 120 for intra-modal gallery expansion and score aggregation. Scores of all available modalities are then subject to a multi-modal fusion 125 and aggregated by choosing the most appropriate multimodal classifier from a small bank of classifiers 130. The size of the bank depends on the number of modalities, not on the number of possible biometric systems. The context in which the biometric samples were acquired (e.g., standoff, sensors, collaborative, etc.) is used at 135 and aggregated at 140, as well as prior knowledge of registered subject associations and events to make a final determination about identity of the subject at 145.

In fusing within a modality across different biometric sensors, depending on the circumstances, a different sensor or set of sensors can be used to acquire biometric samples. Moreover, within each modality the circumstances will dictate the set of sensors to employ to collect probes (such as high resolution camera vs. low resolution camera).

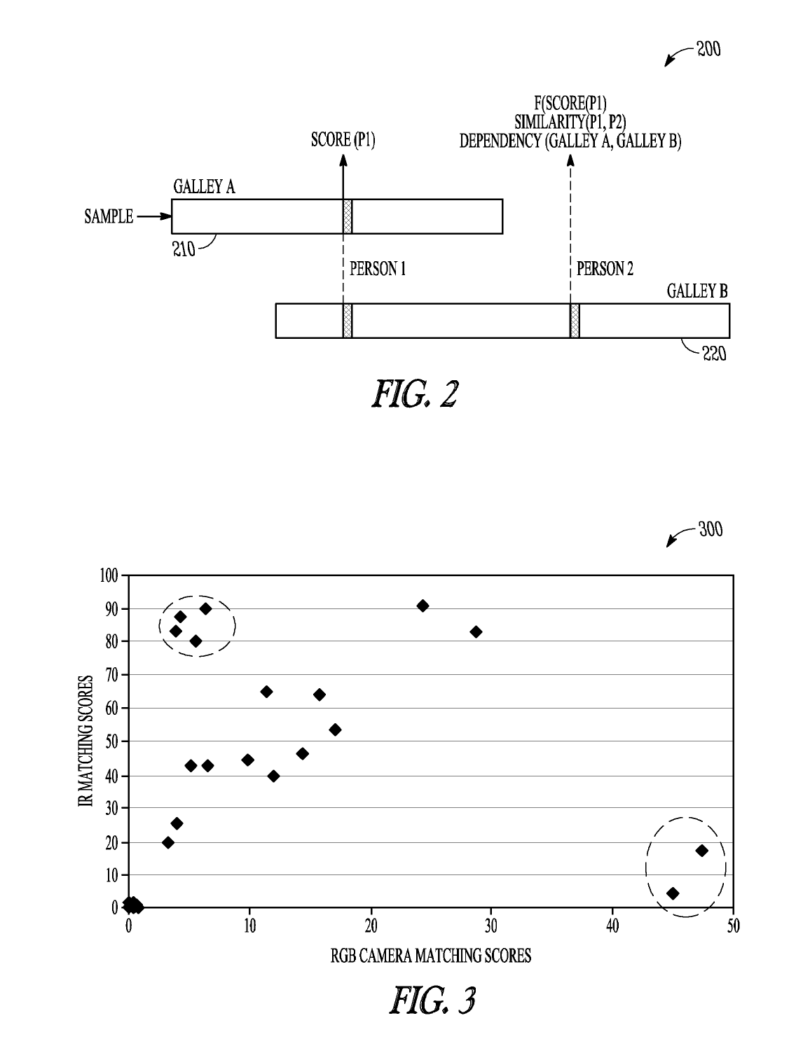

As new biometric sensors and algorithms are developed and deployed, the databases of registered subjects for each biometric system will have decreased overlap even within the same modality. While biometric modalities are independent, the measurements and their corresponding biometric scores taken within a modality are related and can be leveraged during recognition and verification time. This circumstance is due to the fact that various sensors and algorithms within each modality exploit the same or related biometric features. Thus, if two individuals have similar scores according to one biometric system, there is a high probability they will have similar scores in another biometric system that measures the same modality, (e.g. optical and ultrasonic fingerprint sensors, electro-optical and near infrared face cameras). Under this assumption, scores of subjects can be estimated from the galleries of unavailable biometric systems that are similar to the people that are registered in both unavailable and available biometric fusion. FIG. 2 illustrates at 200 an example of an extension of gallery coverage within a same modality.

To ensure that spurious scores are not introduced, in an embodiment only people who have high scores are used in the available biometric system to find similar people in unavailable biometric systems. Only high similarity groups are considered. The scores are calculated as a function of original score, similarity measure, and relationships between biometric systems. The precise relationship between scores can be discovered using machine learning techniques such as PCA, clustering and correlation analysis, or Bayesian analysis.

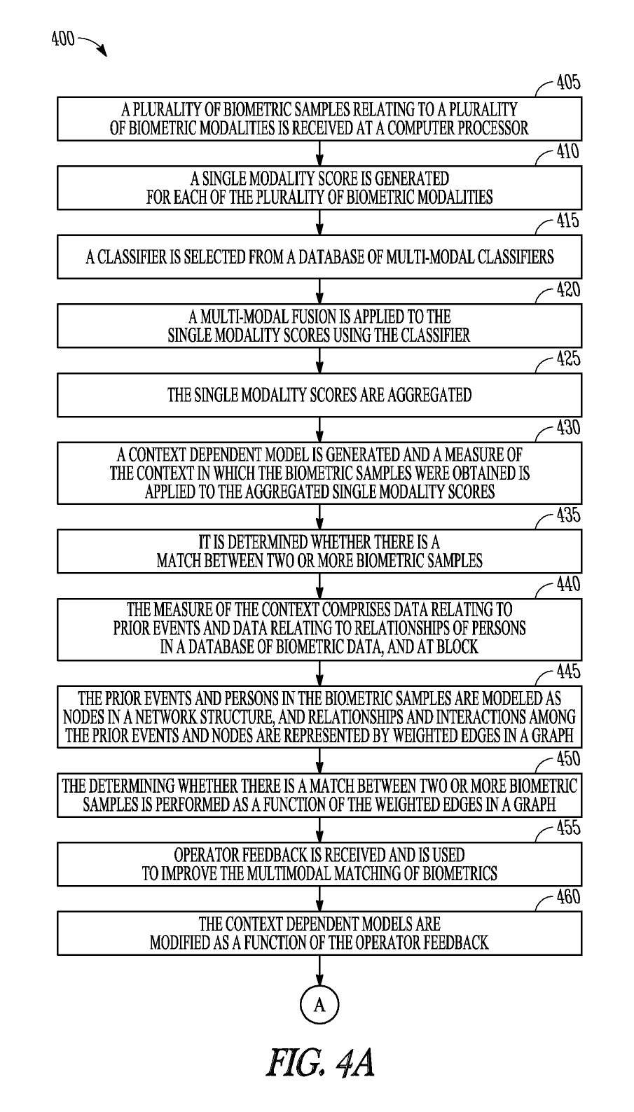

FIG. 3 illustrates at 300 an example relationship between log-scaled matching scores of IR and RGB camera galleries of nine individuals photographed under various conditions (such as distance from the camera and head position). The group consists of three clusters of three similar individuals in each cluster. The scores were computed using a commercial off the shelf (COTS) face matching algorithm. In general, any log-scaled score above 5 represents a good match. The plot demonstrates that, in general, dissimilar individuals will have lower scores in both IR and RGB galleries, while more similar individuals will have higher scores in both galleries. As demonstrated by the circled matching scores in FIG. 3, the relationship between scores is not a simple function of just the scores. The complexity of the relationships between the scores will depend on the variability in data acquisition of various devices within the same modality. The main factor that affects the relationships between scores is the mismatch between acquisition devices. Other factors include distortions due to the environment (for example lightning conditions for face recognition system) and user-device interactions (for example misplaced fingerprint relative to the capture device).

These factors are hard to capture in real-life scenarios and moreover may not be available, therefore rather than including explicit factors in the relationship model of scores from different galleries, “match quality” that affects score relationships is implicitly modeled. The “match quality” measure can be estimated based on local quality of each sample and will be modality-dependent, such as fingerprint coherence measure for fingerprint modality, and iris quality assessment for irises.

In the context of combining scores from different modalities, several schemes can adaptively weigh individual matchers based on the quality scores. These approaches show that adaptation of the fusion functions at the score level in multimodal biometrics can report significant verification improvements. Prior systems have presented a likelihood ratio-based approach to perform quality-based fusion of match scores in a multi-biometric system. Other prior systems have implemented adaptive weight estimation components for the face biometrics using a user's head pose and image illumination as well as for finger biometrics using users' positioning and image clarity.

If several subjects registered in an available biometric system exhibit scores that are similar to a specific person in an unavailable biometric system, the score for that subject can be computed based on a voting scheme or can be based on the score of the most similar subject in the available biometric system. The similarity of registered subjects within each biometric system is calculated a priori by probing the gallery of a biometric system with samples of each registered subject and calculating matching scores of everyone else in the gallery.

Once the pool of candidate matches is expanded, when multiple biometric systems are available within the same modality, their scores are fused into one score before aggregating scores from other modalities. Since the quality of biometric samples has a significant impact on the accuracy of the matcher, weights are dynamically matched to the scores of individual biometric systems based on the quality of samples to improve recognition performance.

In practice, one is often confronted with the problem of positively identifying a person in the presence of a set of candidate matches with high similarity scores provided by parametric classifiers of high accuracy. Recognition accuracy is improved by considering the context in which particular subjects are observed, since biometric probes are rarely acquired in isolation. The context, such as location and time of the biometric samples acquisition combined with prior knowledge of association of subjects in the galleries, can provide ancillary information and can be used to further improve recognition and verification accuracy.

Additionally, many existing biometric systems collect supplementary information from users during enrollment. This may include soft biometrics traits (such as gender and height), behavioral biometrics (such as signature and gait), personal information (such as location of residence, the make of the car owned, etc.). While these characteristics lack the distinctiveness and permanence of hard biometrics, they can provide additional evidence to reliably identify the subject. In fact, it has been shown that integrating soft biometrics to a unimodal biometric system can improve the accuracy of the system.

In an embodiment, the ancillary information, context, and subject associations are embedded in a social network structure by modeling registered subjects from the galleries and subjects whose identities one is trying to determine as nodes and their relationships and interactions as edges. This approach can be effectively formalized as joint classification of multiple nodes in the network. Joint classification enables modeling of dependence between nodes, allowing structure and context to be taken into account.

More specifically, each node representing a subject whose identify one wants to establish is connected to nodes representing registered subjects from the galleries through matching scores based on hard biometrics. The weight of the edge is determined via combined biometrics match score. The higher the score, the higher is the weight. Similarly, the edge exists between a subject of interest and a registered subject for each match based on ancillary information. The weight of the edge represents the strength of the relationship. For example, the weight of a signature relationship represents a similarity score between a signature of subject of interest and a signature of registered user, the weight of the hair color edge represents a similarity score between the hair color of the subject of interest and the hair color of registered user, etc.

Moreover, the context in which biometric verification takes place can also be used to connect measured subjects and registered users. For example, if information about the car owned by registered users is known for some of them, and during verification the system becomes aware of the car used by the measured subject (through video analytics for example), the match between those cars can be used to connect registered users and subjects of interest. Similarly, location of the registered users (such as location of residence, current location, etc.) can be used to connect them to the measured subject. The strength of such relationships is determined by the match on the objects of registered users and measured subjects.

In addition to relationships between subjects of interest and registered users, two other types of relationships are modeled—relationships between subjects of interest, and relationships between registered users. Registered users can be related to other registered users through events in which they jointly participated, their associations, such as being members of the same group or family, etc. Subjects of interest can be related to each other through location and/or time at which their biometric samples were taken or through an event which triggered the collection of samples to determine subjects' identities.

An embodiment is based on conditional random fields (CRFs) that jointly analyze all nodes of the network. Classification of each aggregated score affects the classification of each neighbor in the network. More specifically, for example, assume x represents all subjects of interest along with all known ancillary features such their biometrics as well as the context in which the samples were taken. The objective is to infer a joint labeling y={yᵢ} of identities over all nodes i in the graph. In general the list of possible identities is quite large for each measured subject and consists of all matches to registered subjects in the galleries, therefore it might be beneficial to use thresholds to limit the list of possible identities for each measured subject to only higher valued matches.

An optimal joint labeling is found by maximizing the conditional density

$$Pr ( y \vert x ) = \frac{1}{Z ( x )} exp ( E ( y \vert x ) ) ,$$

where Z(x) is a normalization factor and energy E(y|x) is the sum of potential functions representing relationships between nodes of a social network:

E(y|x)=Σᵢφᵢ(yᵢ|x)+Σ_{i,j≠i}φᵢⱼ(yᵢ,yⱼ|x).

In a framework, the univariate potential function φᵢ (yᵢ|x) will capture the strength of relationships between measured subjects x and their potential identities (enrolled users) y. More precisely:

φᵢ(yᵢ|x)=Σ_{feature}α_{feature}ƒ_{feature}(yᵢ,xₗᵢ)

Each function ƒ_{feature}(yᵢ|xₗᵢ) measures “distance” between subject of interest xₗᵢ and its potential identity yᵢ. For example, in the case of hard biometrics, the function will represent combined biometrics match score between measured subject xₗᵢ and enrolled user yᵢ. The bivariate potential function φᵢⱼ(yᵢ, yⱼ|x) will represent prior interactions and associations among pairs of enrolled users and pair of measured subjects. Namely,

φᵢⱼ(yᵢ,yⱼ|x)=Σ_{association}(β_{association}association_indicator(yᵢ,yⱼ)Σₖwₖcₖ(xₗᵢ,xₘⱼ)),

where association_indicator is a boolean-valued function equal to 1 when there exists prior association between yᵢ and yⱼ, cₖ is a boolean-valued constraint function equal to 1 if there exists prior association of type cₖ between measured subjects xₗᵢ (of potential identity yᵢ) and xₘⱼ (of potential identity yⱼ) and wₖ is the weight of the constraint cₖ.

To illustrate this concept, the following example of five registered users and two measured subjects whose identity is to be established in connection with an event is used. In this example, registered measured subject's s₁ true identity is ru₁ and registered measured subject's s₂ true identity is ru₂, the normalized similarity scores are shown below in Table 1. In the absence of additional information it is hard to decide whether or not to identify s₁ as ru₁ or ru₄, as well as whether or not to identify s₂ as ru₂ or ru₅.

TABLE 1
Similarity Scores between Measured Subjects and Registered Users

| | ru₁ | ru₂ | ru₃ | ru₄ | ru₄ |
|---|---|---|---|---|---|
| s₁ | 0.76 | 0.52 | 0.04 | 0.76 | 0.55 |
| s₂ | 0.32 | 0.7 | 0.56 | 0.49 | 0.7 |

Assuming that ru₁ and ru₂ have prior association through being members of the same organization, ru₃ or ru₄ have prior association through past activities, and finally s₁ or s₂ were measured in connection with the same event. Under the assumption that α=1, β=0.1 and w=1, the energy E(y|x) for various identity assignments is shown below.

E(s₁=ru₁,s₂=ru₂)=0.76+0.7+0.1=1.56

E(s₁=ru₄,s₂=ru₅)=0.76+0.7=1.46

E(s₁=ru₄,s₂=ru₃)=0.76+0.49+0.1=1.35

Based on the above calculations, the most probable identity assignment is s₁=ru₁ and s₂=ru₂. To meaningfully combine different types of relationships between registered subjects x and their potential identities (enrolled users) y, a conditional random fields model is used to estimate posterior distribution of parameters during training and aggregate predictions at time of recognition. For this model, optimizing the conditional log likelihood L(α,β,w)=Σᵢ log p(yᵢ|xᵢ) in each of the αⱼ, βₖ, and wₗ is the conventional approach.

To support applicability of the system in different environments and to achieve continuous improvement of system accuracy, an embodiment uses operator feedback to improve the multimodal matching of biometrics. Through continuous learning, the system will adapt classification models and their parameters to the changes in biometric systems and situational context and will enable automatic configuration of the system in various environments to minimize deployment costs and improve initial recognition models.

A relevance feedback approach is implemented to leverage the input provided by the operator for improving the multimodal matching of biometrics. This will allow the operator to quickly perform multimodal matching on biometrics acquired in sub-optimal conditions.

An embodiment can be used in combination with Honeywell Corporation's multi-biometrics system—Combined Face and Iris Recognition System (CFAIRS). CFAIRS uses COTS recognition algorithms combined with custom iris processing algorithms to accurately recognize subjects based on the face and iris at standoff distances. CFAIRS performs automatic illumination, detection, acquisition and recognition of faces in visible and near IR wavelengths and left and right irises in near IR wavelength at ranges out to five meters. It combines the collected biometric data to provide a fused multi-modal match result based on data from the individual biometric sensors, match confidences, and image quality measures.

An embodiment can also be used in connection with commercial biometrics engines that allow assessment of the performance of multimodal fusion of biometrics collected by various biometrics systems. An embodiment advocates the use of contextual information for multimodal fusion, and captures contextual observations using a network of surveillance cameras.

An embodiment can produce a False Accept Rate (FAR), a False Reject Rate (FRR), and receiver operating characteristic (ROC) curves that show recognition rates for any particular system. The system can provide a significant increase in the rate of true positive matches without a corresponding increase in the rate of false positive matches. In addition to the above-specified evaluation of the entire system, each subsystem or modules that contributes to the multi-modal fusion system can be quantified.

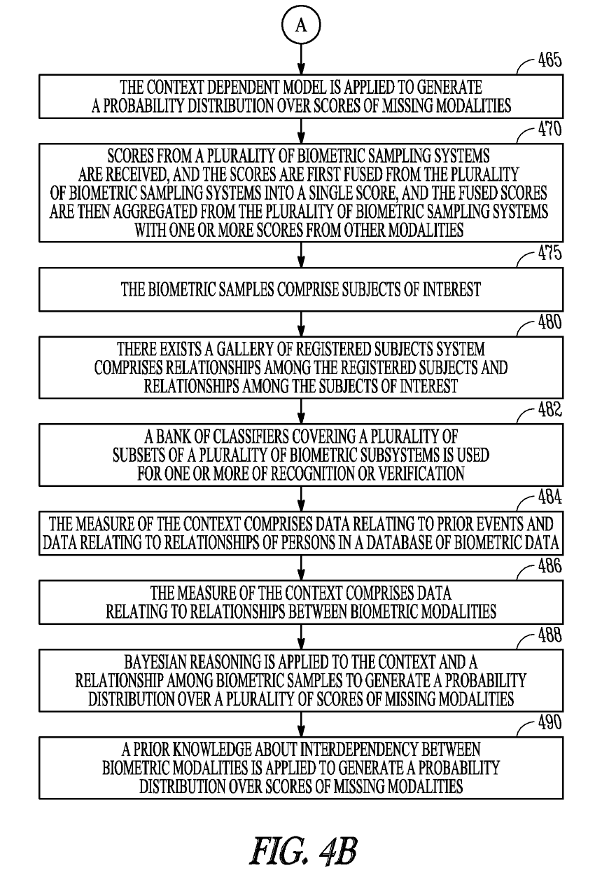

FIGS. 4A and 4B are a flowchart of an example process 400 for a multi-modal biometrics process. FIGS. 4A and 4B include a number of process blocks 405-490. Though arranged serially in the example of FIGS. 4A and 4B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring specifically to FIGS. 4A and 4B, at 405, a plurality of biometric samples relating to a plurality of biometric modalities is received at a computer processor. At 410, a single modality score is generated for each of the plurality of biometric modalities. At 415, a classifier is selected from a database of multi-modal classifiers. At 420, a multi-modal fusion is applied to the single modality scores using the classifier. At 425, the single modality scores are aggregated. At 430, a context dependent model is generated and a measure of the context in which the biometric samples were obtained is applied to the aggregated single modality scores. At 435, it is determined whether there is a match between two or more biometric samples.

The process 400 further includes a block 440 wherein the measure of the context comprises data relating to prior events and data relating to relationships of persons in a database of biometric data, and at block 445, the prior events and persons in the biometric samples are modeled as nodes in a network structure, and relationships and interactions among the prior events and nodes are represented by weighted edges in a graph. At 450, the determining whether there is a match between two or more biometric samples is performed as a function of the weighted edges in a graph.

At 455, operator feedback is received and is used to improve the multimodal matching of biometrics, and at 460, the context dependent models are modified as a function of the operator feedback. At 465, the context dependent model is applied to generate a probability distribution over scores of missing modalities. At 470, scores from a plurality of biometric sampling systems are received, and the scores are first fused from the plurality of biometric sampling systems into a single score, and the fused scores are then aggregated from the plurality of biometric sampling systems with one or more scores from other modalities. At 475, the biometric samples comprise subjects of interest. At 480, there exists a gallery of registered subjects system comprises relationships among the registered subjects and relationships among the subjects of interest.

At 482, a bank of classifiers covering a plurality of subsets of a plurality of biometric subsystems is used for one or more of recognition or verification. At 484, the measure of the context comprises data relating to prior events and data relating to relationships of persons in a database of biometric data. At 486, the measure of the context comprises data relating to relationships between biometric modalities. At 488, Bayesian reasoning is applied to the context and a relationship among biometric samples to generate a probability distribution over a plurality of scores of missing modalities. At 490, a priori knowledge about interdependency between biometric modalities is applied to generate a probability distribution over scores of missing modalities.

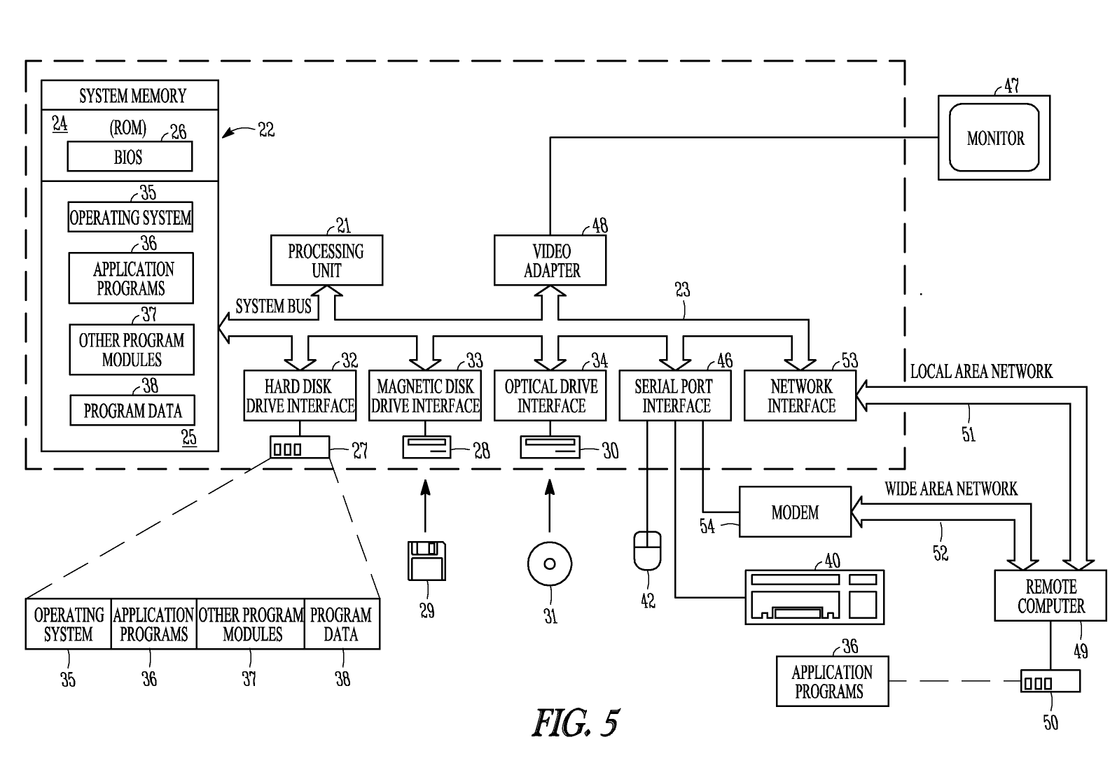

FIG. 5 is an overview diagram of a hardware and operating environment in conjunction with which embodiments of the invention may be practiced. The description of FIG. 5 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 5, a hardware and operating environment is provided that is applicable to any of the servers and/or remote clients shown in the other Figures.

As shown in FIG. 5, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### Example Embodiments

In Example 1, a process comprises receiving a plurality of biometric samples relating to a plurality of biometric modalities, generating a single modality score for each of the plurality of biometric modalities, selecting a classifier from a database of multi-modal classifiers, applying a multi-modal fusion to the single modality scores and the classifier, aggregating the single modality scores, generating a context dependent model and applying a measure of the context in which the biometric samples were obtained to the aggregated single modality scores, and determining whether there is a match between two or more biometric samples.

In Example 2, the examples of Example 1 further optionally includes a process wherein the measure of the context comprises data relating to prior events and data relating to relationships of persons in a database of biometric data.

In Example 3, the examples of Examples 1-2 further optionally include a process wherein the prior events and persons in the biometric samples are modeled as nodes in a network structure, and relationships and interactions among the prior events and nodes are represented by weighted edges in a graph.

In Example 4, the examples of Examples 1-3 further optionally include a process wherein the determining whether there is a match is performed as a function of the weighted edges in a graph.

In Example 5, the examples of Examples 1-4 further optionally include receiving at the processor operator feedback to improve the multimodal matching of biometrics, and modifying the context dependent models as a function of the operator feedback.

In Example 6, the examples of Examples 1-5 further optionally include applying the context dependent model to generate a probability distribution over scores of missing modalities.

In Example 7, the examples of Examples 1-6 further optionally include applying a priori knowledge about interdependency between biometric modalities to generate a probability distribution over scores of missing modalities.

In Example 8, the examples of Examples 1-7 further optionally include receiving scores from a plurality of biometric sampling systems, and first fusing the scores from the plurality of biometric sampling systems into a single score, and then aggregating the fused score from the plurality of biometric sampling systems with one or more scores from other modalities.

In Example 9, the examples of Examples 1-8 further optionally include a process wherein the biometric samples comprise subjects of interest, and further comprising a gallery of registered subjects, and further wherein the process comprises relationships among the registered subjects and relationships among the subjects of interest.

In Example 10, the examples of Examples 1-9 further optionally include applying Bayesian reasoning to the context and a relationship among subjects to generate a probability distribution over a plurality of scores of missing modalities.

In Example 11, a process includes receiving a plurality of biometric samples relating to a plurality of biometric modalities, generating a single modality score for each of the plurality of biometric modalities, applying a multi-modal fusion to the single modality scores using a classifier, aggregating the single modality scores, generating a context dependent model and applying a measure of the context in which the biometric samples were obtained to the aggregated single modality scores, and determining whether there is a match between two or more biometric samples.

In Example 12, the example of Example 11 optionally includes a process wherein a bank of classifiers covering a plurality of subsets of a plurality of biometric subsystems is used for one or more of recognition or verification.

In Example 13, the examples of Examples 11-12 further optionally include a process wherein the measure of the context comprises data relating to prior events and data relating to relationships of persons in a database of biometric data.

In Example 14, the examples of Examples 11-13 further optionally include a process wherein the measure of the context comprises data relating to relationships between biometric modalities.

In Example 15, the examples of Examples 11-14 further optionally include applying Bayesian reasoning to the context and a relationship among biometric samples to generate a probability distribution over a plurality of scores of missing modalities.

In Example 16, the examples of Examples 11-15 further optionally include applying a priori knowledge about interdependency between biometric modalities to generate a probability distribution over scores of missing modalities.

The above-identified examples, in addition to implementation as processes, with or without a computer processor, could further be implemented as a system of one or more computer processors and a machine-readable medium including instructions to execute the processes.

Thus, an example system, method and machine readable medium for multi-modal biometrics have been described. Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)). Consequently, a machine-readable medium can be either transitory, non-transitory, tangible, or intangible in nature.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A computerized process comprising:
receiving at a processor a plurality of biometric samples relating to a plurality of biometric modalities;
generating with the processor a single modality score for each of the plurality of biometric modalities;
selecting a classifier from a database of multi-modal classifiers;
applying a multi-modal fusion to the single modality scores using the processor and the classifier;
aggregating the single modality scores;
generating a context dependent model and applying a measure of the context in which the biometric samples were obtained to the aggregated single modality scores; and
determining whether there is a match between two or more biometric samples.

2. The process of claim 1, wherein the measure of the context comprises one or more of data relating to prior events, data relating to relationships of persons in a database of biometric data, and data relating to relationships to other objects.

3. The process of claim 2, wherein the prior events and persons in the biometric samples are modeled as nodes in a network structure, and relationships and interactions among the prior events and nodes are represented by weighted edges in a graph.

4. The process of claim 3, wherein the determining whether there is a match is performed as a function of the weighted edges in a graph.

5. The process of claim 1, comprising:
receiving at the processor operator feedback to improve the multimodal matching of biometrics; and
modifying the context dependent models as a function of the operator feedback.

6. The process of claim 1, comprising applying the context dependent model to generate a probability distribution over scores of missing modalities.

7. The process of claim 1, comprising applying a priori knowledge about interdependencies across biometric systems within each modality, and generating a score for a missing biometric system such that a more accurate modality score is generated.

8. The process of claim 1, comprising receiving at the computer processor scores from a plurality of biometric sampling systems, and first fusing the scores from the plurality of biometric sampling systems into a single score, and then aggregating the fused score from the plurality of biometric sampling systems with one or more scores from other modalities.

9. The process of claim 1, wherein the biometric samples comprise subjects of interest, and further comprising a gallery of registered subjects, and further wherein the process comprises relationships among the registered subjects and relationships among the subjects of interest.

10. The process of claim 1, comprising applying Bayesian reasoning to the context and a relationship among subjects to generate a probability distribution over a plurality of scores of missing modalities.

11. A computerized process comprising:
receiving at a processor a plurality of biometric samples relating to a plurality of biometric modalities;
generating with the processor a single modality score for each of the plurality of biometric modalities;
applying a multi-modal fusion to the single modality scores using the processor and a classifier;
aggregating the single modality scores;
generating a context dependent model and applying a measure of the context in which the biometric samples were obtained to the aggregated single modality scores; and
determining whether there is a match between two or more biometric samples.

12. The process of claim 11, wherein a bank of classifiers covering a plurality of subsets of a plurality of biometric subsystems is used for one or more of recognition or verification.

13. The process of claim 11, wherein the measure of the context comprises data relating to prior events and data relating to relationships of persons in a database of biometric data.

14. The process of claim 11, wherein the measure of the context comprises data relating to relationships between biometric systems within a biometric modality.

15. The process of claim 11, comprising applying Bayesian reasoning to the context and a relationship among biometric samples to generate a probability distribution over a plurality of scores of missing modalities.

16. The process of claim 11, comprising applying a priori knowledge about interdependency between biometric modalities to generate a probability distribution over scores of missing modalities.

17. A machine-readable medium storing instructions, which, when executed by a processor, cause the processor to perform a process comprising:
receiving at a processor a plurality of biometric samples relating to a plurality of biometric modalities;
generating with the processor a single modality score for each of the plurality of biometric modalities;
applying a multi-modal fusion to the single modality scores using the processor and a classifier;
aggregating the single modality scores;
generating a context dependent model and applying a measure of the context in which the biometric samples were obtained to the aggregated single modality scores; and
determining whether there is a match between two or more biometric samples.

18. The machine-readable medium of claim 17,
wherein a bank of classifiers covering a plurality of subsets of a plurality of biometric subsystems is used for one or more of recognition or verification;
wherein the measure of the context comprises data relating to prior events and data relating to relationships of persons in a database of biometric data; and
wherein the measure of the context comprises data relating to relationships between biometric modalities.

19. The machine-readable medium of claim 17, comprising instructions for applying Bayesian reasoning to the context and a relationship among biometric samples to generate a probability distribution over a plurality of scores of missing modalities.

20. The machine-readable medium of claim 17, comprising instructions for applying a priori knowledge about interdependency between biometric modalities to generate a probability distribution over scores of missing modalities.
